(19) United States
(12) Patent Application Publication
(10) Pub. No.: US 2013/0230360 A1
(43) Pub. Date: Sep. 5, 2013

(54) EDGE OF A TOOL

(71) Applicant: Reuven PORAT, Nahariya (IL)

(72) Inventor: Reuven PORAT, Nahariya (IL)

(21) Appl. No.: 13/410,394

(22) Filed: Mar. 2, 2012

(51) Int. Cl. B23B 27/22; B23B 27/00

(52) U.S. Cl. 407/115; 407/120

(57) ABSTRACT

Disclosed is an edge for a tool and/or for an insert to be removably and/or fixedly mountable on a tool. The edge is formed at a meeting of a first surface and a second surface comprises at least one segment extending from a first peak to a second peak through a nadir interposed therebetween. The first peak has a first peak line passing therethrough, the second peak having a second peak line passing therethrough, and the nadir having a nadir line passing there-through. The first peak line, the second peak line, and the nadir line are parallel to each other, and a first depth D1 between the nadir line and the first peak line is greater than a second depth D2 between the nadir line and the second peak line.

### FIELD OF THE INVENTION

Disclosed is an edge for a segment of a tool and/or an insert for a tool, adapted to the chip-removing-machining of materials.

### BACKGROUND OF THE INVENTION

Generally, a segment, be it of a solid tool or of an insert designed to be permanently and/or removably connected (such as by a screw, a pin, a clamp, and/or brazed or welded) may comprise a rake face (over which chips removed from a workpiece flow) and a relief face whereby the workpiece and the working end move relatively to each other. The rake face and the relief face inter-sect to define an edge therebetween. The edge may be designed to machine, or remove chips, from the workpiece. Such chip removal necessitates penetrating a workpiece surface to shear-off material chips. To facilitate penetration, it is usually useful to elongate the cutting edge more than the span of the material to be removed. This may be achieved by meandering the cutting edge.

As an example, U.S. Pat. No. 7,101,122 shows therein (see FIGS. 1 and 2 here, titled “prior art” and depicting original FIGS. 1 and 5 in the above-cited document) discloses, inter alia, “ . . . The upper face 12 is further provided with a breaker inclined surface 12D which inclines such that the distance from the bottom face 11 decreases as the distance from the plane surface 12C increases (toward the pair of cutting edges 17) to connect the plane surface 12C disposed around the through hole 19 to the inclined surfaces 12A and 12B and the undulating portions 16.” . . . .

. . . “Here, the cutting edges 17, which exhibit a wavy shape due to the concave portions 14 and the convex portions 15 of the undulating portions 16, will be explained in detail. As shown in FIG. 5, when viewing the cutting edge 17 in the direction along which the concave portions 14 and the convex portions 15 extend, while viewing the side face 13, that is, as viewed in an imaginary diagram in which the substantially arc-shaped cutting edge 17 is deformed as a plane, the cutting edge 17 exhibits a wavy shape in which curves, each having different radii of curvature, are smoothly connected one after another.

“Moreover, as shown in FIG. 5, among the concave portions 14 of the cutting edge 17, the depth HB of the first shallow-concave portion 14B, which is defined by a distance between apices 15X of the convex portions 15 (the levels of the apices 15X are arranged to be the same with respect to each other, and the apices 15X are disposed in substantially the same plane as the plane portion 12C) and the bottom 14X of the concave portion 14 measured along the direction of thickness of the throwaway insert 10, that is, along a direction perpendicular to the bottom face 11, is set to be substantially equal to the depth HD of the second shallow-concave portion 14D, and the depths HB and HD are preferably set in a range from 0.3 to 1.2 mm. In this embodiment, both the depth HB of the first shallow-concave portion 14B and the depth HD of the second shallow-concave portion 14D are set to be 0.8 mm.

“As is also shown in FIG. 5, among the concave portion 14 of the cutting edge 17, the depth HC of the second deep-concave portion 14C is set to be greater than the depth HA of the first deep-concave portion 14A, and the depths HA and HC are preferably set in a range from 1.2 to 3.0 mm. In this embodiment, the depth HA of the first deep-concave portion 14A is set to be 2.0 mm, and the depth HC of the second deep-concave portion 14C is set to be 2.4 mm . . . .”

It would be desirable to have an improved edge that offers improved chip-removing machining performance. This may be attained with the subject matter in accordance with the claims.

### SUMMARY OF THE INVENTION

In the following disclosure, aspects thereof are described and illustrated in conjunction with systems and methods which are meant to be exemplary and illustrative, not limiting in scope.

The present invention is broadly related to a cutting edge for a cutting segment intended to cut or remove chips from materials. The edge is formed at a meeting of a first surface and a second surface comprises at least one segment extending from a first peak to a second peak through a nadir disposed therebetween. The first peak has a first peak line passing therethrough, the second peak has a second peak line passing therethrough, and the nadir having a nadir line passing therethrough. The first peak line, the second peak line, and the nadir line are parallel to each other, and a first depth D1 between the nadir line and the first peak line is greater than a second depth D2 between the nadir line and the second peak line.

Possibly, the first surface may act as a rake face while the second face acts as a relief face. Alternatively, the first surface may act as a relief face while the second face acts as a rake face.

Possibly, the rake face undulates. However, alternatively, the relief face undulates.

Optionally, a plurality of adjacent segments may be formed, each edge of a respective segment may meander from the first peak to the second peak through the nadir. The first peaks may define a first peak line, the second peaks may define a second peak line, and the nadirs may define a nadir line, so that the first peak line is associated with a first peak plane extending parallel to a second peak plane associated with the second peak line and parallel to a nadir plane extending through the nadir line.

Moreover, the edge may be formed at a meeting of a first surface and a second surface which comprises at least one segment extending from a first peak to a second peak through a nadir interposed therebetween. The first peak may have a first peak normal passing therethrough, the second peak may have a second peak normal passing therethrough, and the nadir may have a nadir normal passing therethrough, so that the first peak normal, the second peak normal, and the nadir normal are parallel to each other and extend generally transversely to the edge.

Furthermore, a first breadth B1 between the nadir normal and the first peak normal is smaller than a second breadth B2 between the nadir normal and the second peak normal.

Possibly, the edge may comprise a plurality of adjacent segments, each segment meandering from the first peak to the second peak through the nadir.

Optionally, the plurality of segments may be arranged so that two adjacent first peaks merge.

Alternatively, the plurality of segments is arranged so that two adjacent second peaks merge.

Possibly, any two adjacent nadirs may be separated by two merging first peaks.

Alternatively, each two adjacent nadirs may be separated by two merging second peaks.

In addition to the exemplary aspects and embodiments described above, further aspects and embodiments will become apparent by reference to the figures and by study of the following detailed descriptions.

### BRIEF DESCRIPTION OF DRAWINGS

Exemplary and/or illustrative embodiments of the present disclosure will be presented herein below in the following figures, by way of example only. The figures are not necessarily to scale, and some features may be exaggerated or minimized and/or roughly shown and/or omitted entirely, to show de-tails of particular components, intending that the present disclosure may become more fully understood from the detailed description and the accompanying schematic figures, wherein:

FIG. 1 shows FIG. 1 of prior-art reference U.S. Pat. No. 7,101,122;

FIG. 2 shows corresponding FIG. 5 of the above-referenced prior-art;

FIG. 3 is a schematic perspective view of a first exemplary embodiment of a cutting segment in accordance with the present invention;

FIG. 4 is a schematic detail view of the first cutting segment shown on FIG. 3;

FIG. 5 is a schematic partial perspective detail view of a second exemplary embodiment of a cutting segment in accordance with the present invention;

FIG. 6 is a schematic partial perspective view of a generalized exemplary embodiment of a cutting tool carrying a schematic cutting segment in accordance with the present invention;

FIG. 7 is a schematic detail elevation view of a third exemplary embodiment of the generalized cutting segment shown on FIG. 6;

FIG. 8 is a schematic detail elevation view of a fourth exemplary embodiment of the generalized cutting segment shown on FIG. 6;

FIG. 9 is a perspective detail view of a fifth exemplary embodiment of a cutting segment in accordance with the present invention; and

FIG. 10 is a detail plan view of the fifth exemplary embodiment of the cutting segment shown on FIG. 9.

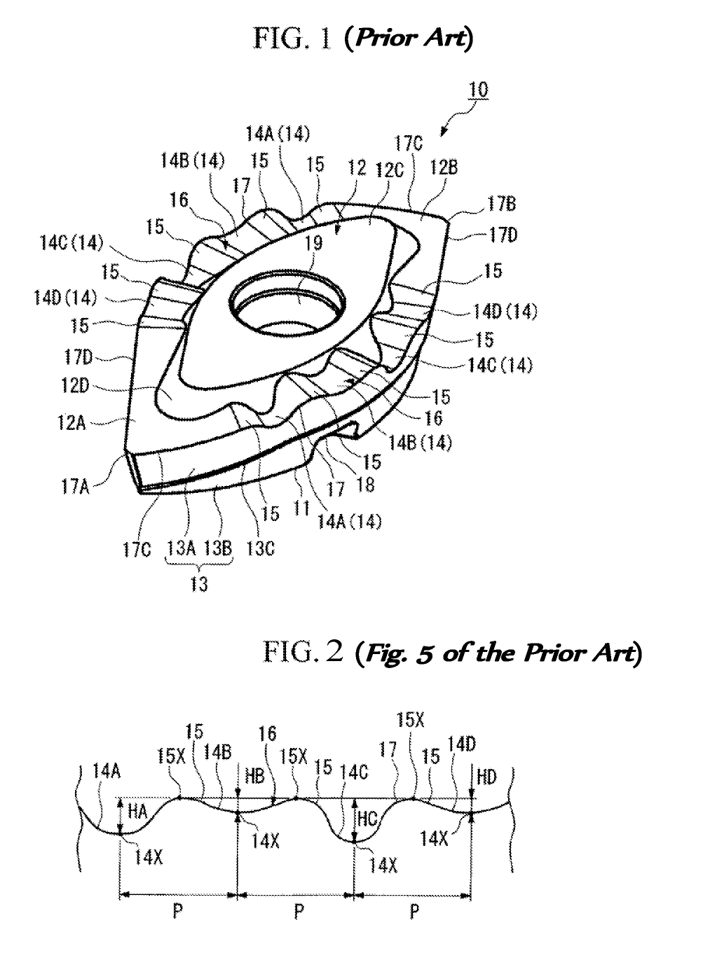

### DETAILED DESCRIPTION OF THE EMBODIMENTS

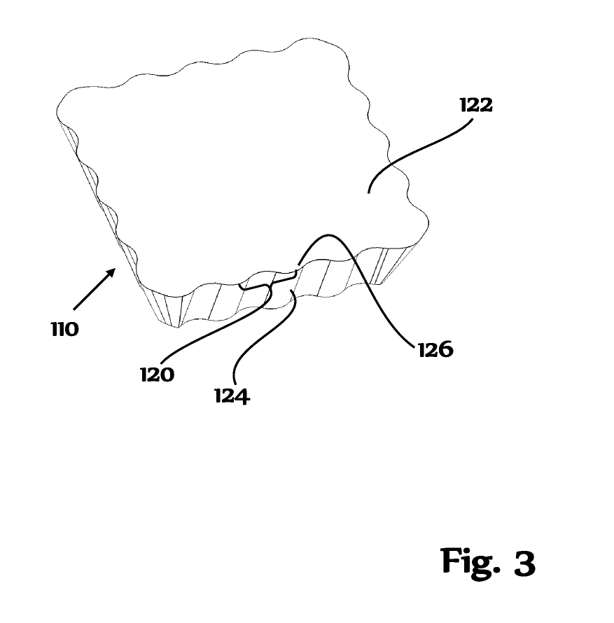

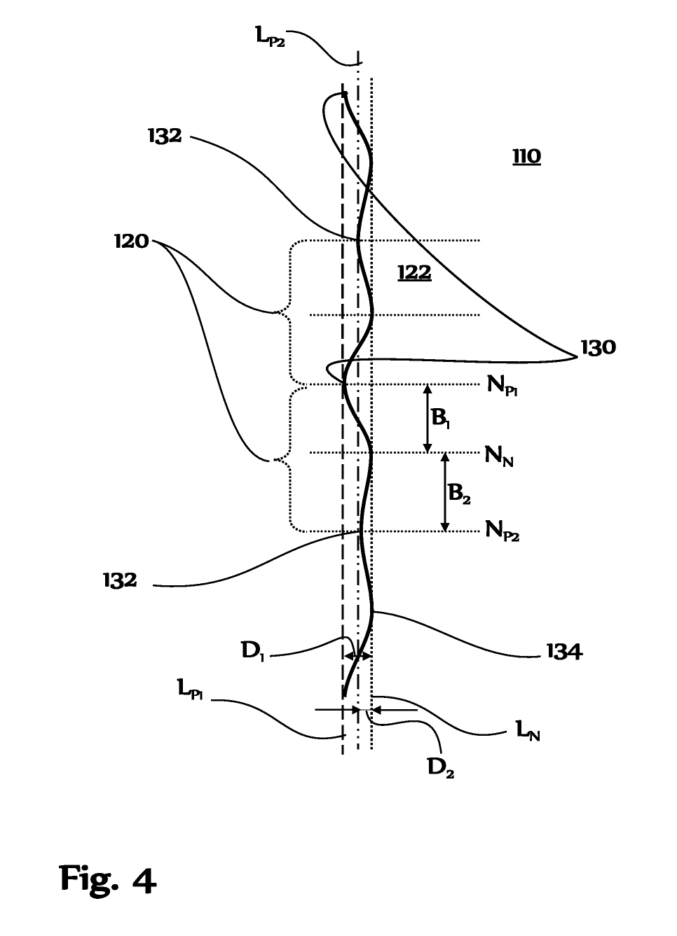

Attention is drawn to FIG. 3. An exemplary-only schematic illustration of a first embodiment of an insert 110 (also known in the art as a cutting plate and/or a cutting bit, among other variants) is shown. While in FIG. 3 there appears an exemplary-only illustration of a generally square shaped insert 110, many other shape variants, such as, but not limited to, rectangular, rhomb, parallelogram, any polyhedral shape and/or any generally rounded shapes, including, but not limited to, circular and/or generally circular shapes, to name a few, are known and used in the art. The first insert 110 may comprise at least one first segment 120. The at least one first segment 120 comprises a first surface 122 and a second surface 124. The first surface 122 and the second surface 124 meet at an edge 126. Generally, when operative, the edge may be directed towards, and may bear against, a material of a work-piece from which chips are intended to be removed to machine the work-piece. As best appreciated from FIG. 4, the edge 126 meanders to comprise at least one first peak 130 and at least one second peak 132 with a nadir 134 disposed therebetween. The first and second peaks 130,132 are defined as local maxima, while the nadir 134 is defined as a local minimum of the edge 126 of the at least one first segment 120. In the first embodiment discussed here, the first surface 122 of the at least one first segment 120 may act as a rake face, while the second surface 124 of the at least one first segment 120 may act as a relief face, as is known in the art. In the first embodiment, the relief face is undulated, causing the edge 126 to meander.

Attention continues with respect to FIG. 4. The edge 126 of the at least one first segment 120 extends from the first peak 130 dipping down to the nadir 134 and away therefrom to the second peak 132. A nadir line L_{N} to the edge 126 passes through the nadir 134. A first peak line L_{P1} and a second peak line L_{P2} to the edge 126 run parallel to the nadir line L_{N} through the first peak 130 and the second peak 132 respectively. In this particular embodiment of the cutting segment 120, a first depth D₁ between the nadir line L_{N} and the first peak line L_{P1} is greater than a second depth D₂ between the nadir line L_{N} and the second peak line L_{P2}. A nadir normal N_{N} normal to the nadir 134 extends parallel to a first peak normal N_{P1} normal to the first peak 130 and to a second peak normal N_{P2} normal to the second peak 132. A first breadth B₁ between the nadir normal N_{N} and the first peak normal N_{P1} is smaller than a second breadth B₂ between the nadir normal N_{N} and the second peak normal N_{P2}. When two or more second segments 120 exist adjacent to each other on a same or similar bearing, their respective nadirs 134 may rest at the distance D₁ from the adjacent first peak 130.

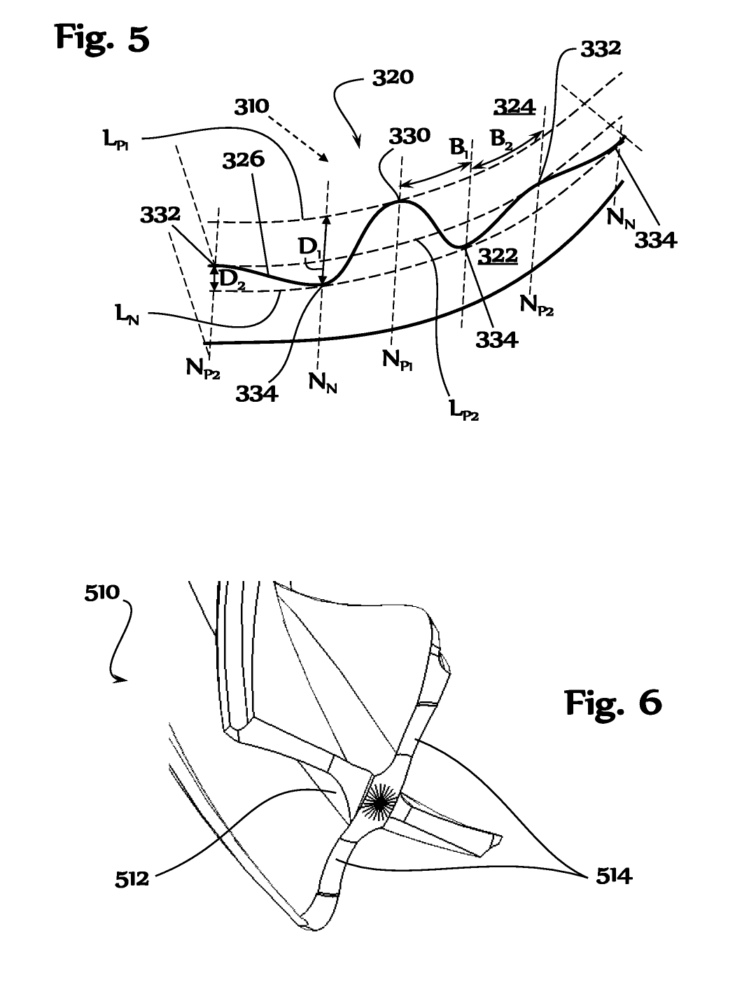

Attention is now directed to FIG. 5. An exemplary-only schematic illustration of a second embodiment of an at least one segment 320 of a second cutting insert 310 (illustrated only partially) is shown. The at least one second segment 320 may have many features similar to those of the at least one first segment 120. Similar features will be related to with similar numerals, increased by 200. The at least one second segment 320 comprises a first surface 322 and a second surface 324. The first surface 322 and the second surface 324 meet at an edge 326. The edge 326 meanders to comprise at least one first peak 330 and at least one second peak 332 with a nadir 334 interposed there-between. The first and second peaks 330,332 are defined as local maxima, while the nadir 334 is defined as a local minimum of the edge 326 of the at least one cutting segment 320 of the second cutting insert 310. In the second embodiment discussed here, the first surface 322 of the at least one second segment 320 may act as a relief face, while the second surface 324 of the at least one second segment 320 may act as a rake face, as is known in the art.

The edge 326 of the at least one second segment 320 extends from the first peak 330 dipping down to the nadir 334 and away therefrom to the second peak 332. A nadir line L_{N} to the edge 326 passes through the nadir 334. A first peak line L_{P1} and a second peak line L_{P2} to the edge 326 run parallel to the nadir line L_{N} through the first peak 330 and the second peak 332 respectively. In this particular embodiment of the cutting segment 320, a first depth D₁ between the nadir line L_{N} and the first peak line L_{P1} is greater than a second depth D₂ between the nadir line L_{N} and the second peak line L_{P2}. A nadir normal N_{N} normal to the nadir 334 extends parallel to a first peak normal N_{P1} normal to the first peak 330 and to a second peak normal N_{P2} normal to the second peak 332. A first breadth B₁ between the nadir normal N_{N} and the first peak normal N_{P1} is smaller than a second breadth B₂ between the nadir normal N_{N} and the second peak normal Nₙ. When two or more second segments 320 exist adjacent each other on a same or similar bearing, their respective nadirs 334 may rest at the distance D₁ from the adjacent first peak 330.

When a curved edge exists (as is exemplarily illustrated on FIG. 5, but not limited to that particular embodiment) with a plurality of first peaks, a plurality of second peaks, and a plurality of nadirs, the plurality of first peaks may lie on the same first peak line, the plurality of second peaks may lie on the same second peak line, and the plurality of nadirs may lie on the same nadir line. The first peak line is associated with a first peak plane, the second peak line being associated with a second peak plane, and the nadir line is associated with a nadir plane, with the first peak plane, second peak plane, and the nadir plane being parallel to each other. In the first embodiment, the rake face is undulated, causing the edge 326 to meander.

Attention is now directed to FIG. 6, showing a schematic partial perspective view of a generalized exemplary embodiment of a tool 510 carrying at least one schematic generalized cutting segment in accordance with the present invention. The tool 510, in this case a solid end mill and/or a drill and/or a combination thereof, has a generally longitudinally extending center core 512 and at least one lobe 514 extending generally radially away therefrom.

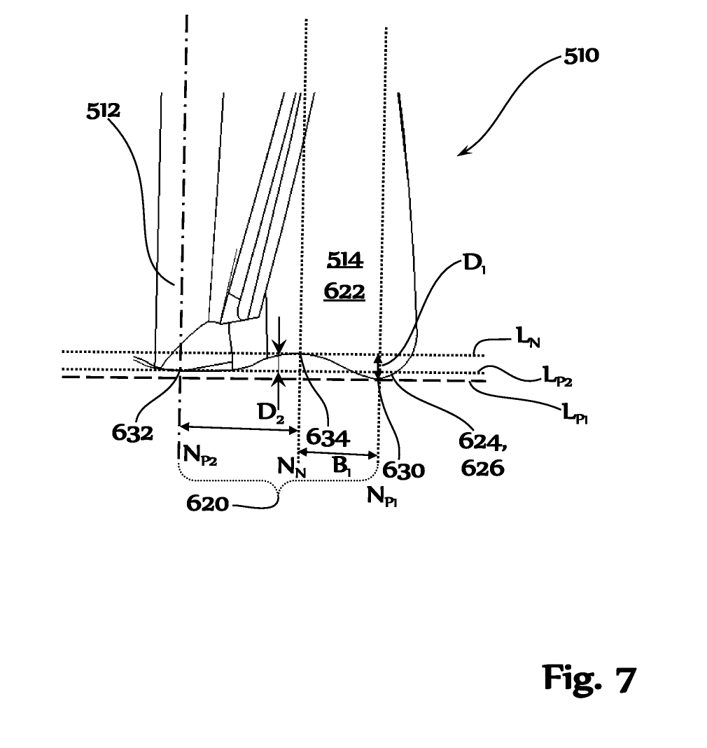

Drawing attention now additionally to FIG. 7, there is shown a third embodiment of an at least one segment 620 of the tool 510 (illustrated only partially). The at least one third segment 620 may have many features similar to those of the at least one first segment 120. Similar features will be related to with similar numerals, increased by 500. The at least one third segment 620 comprises a first surface 622 and a second surface 624. The first surface 622 and the second surface 624 meet at an edge 626. The edge 626 meanders to comprise at least one first peak 630 and at least one second peak 632 with a nadir 634 interposed therebetween. The first and second peaks 630, 632 are defined as local maxima, while the nadir 634 is defined as a local minimum of the edge 626 of the at least one third segment 620 of the tool 510. In the third embodiment discussed here, the first surface 622 of the at least one third segment 620 may act as a rake face, while the second surface 624 of the at least one third segment 620 may act as a relief face, as is known in the art.

The edge 626 of the at least one third segment 620 extends from the first peak 630 dipping down to the nadir 634 and away therefrom to the sec- and peak 632. A nadir line L_{N} to the edge 626 passes through the nadir 634. A first peak line L_{P1} and a second peak line L_{P2} to the edge 626 run parallel to the nadir line L_{N} through the first peak 630 and the second peak 632 respectively. In this particular embodiment of the at least one third segment 620, a first depth D₁ between the nadir line L_{N} and the first peak line L_{P1} is greater than a second depth D₂ between the nadir line L_{N} and the second peak line L_{P2}. A nadir normal N_{N} normal to the nadir 634, a first peak normal N_{P1} normal to the first peak 630, and a second peak normal N_{P2} normal to the second peak 632 ex-tends parallel to each other and perpendicularly to the nadir line L_{N}, first peak line L_{P1} and the second peak line L_{P2}. A first breadth B₁ between the nadir normal N_{N} and the first peak normal N_{P1} is smaller than a second breadth B₂ between the nadir normal N_{N} and the second peak normal N_{P2}. When two or more second segments 620 exist adjacent each other on a same or similar bearing, their respective nadirs 634 may rest at the distance D₁ from the adjacent first peak 630.

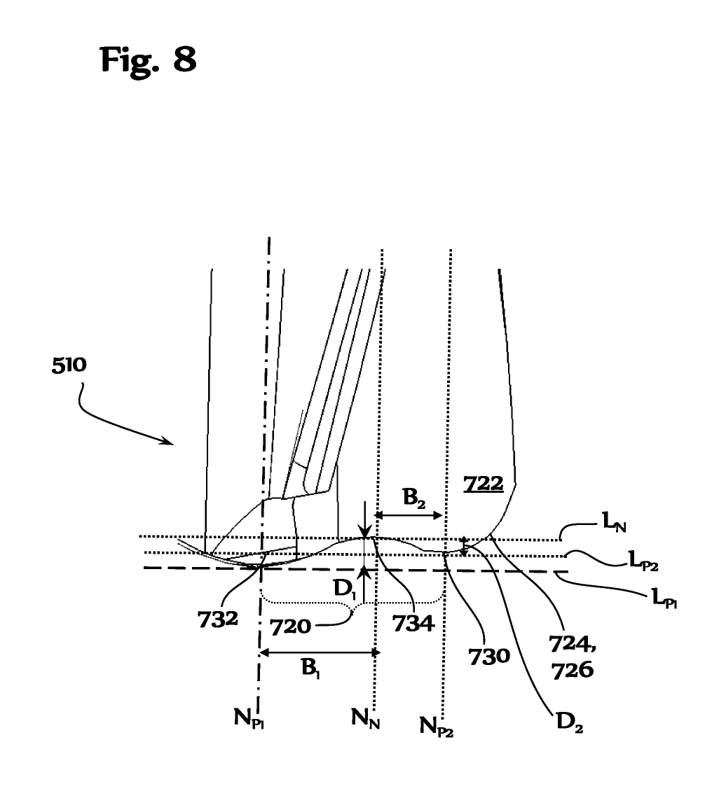

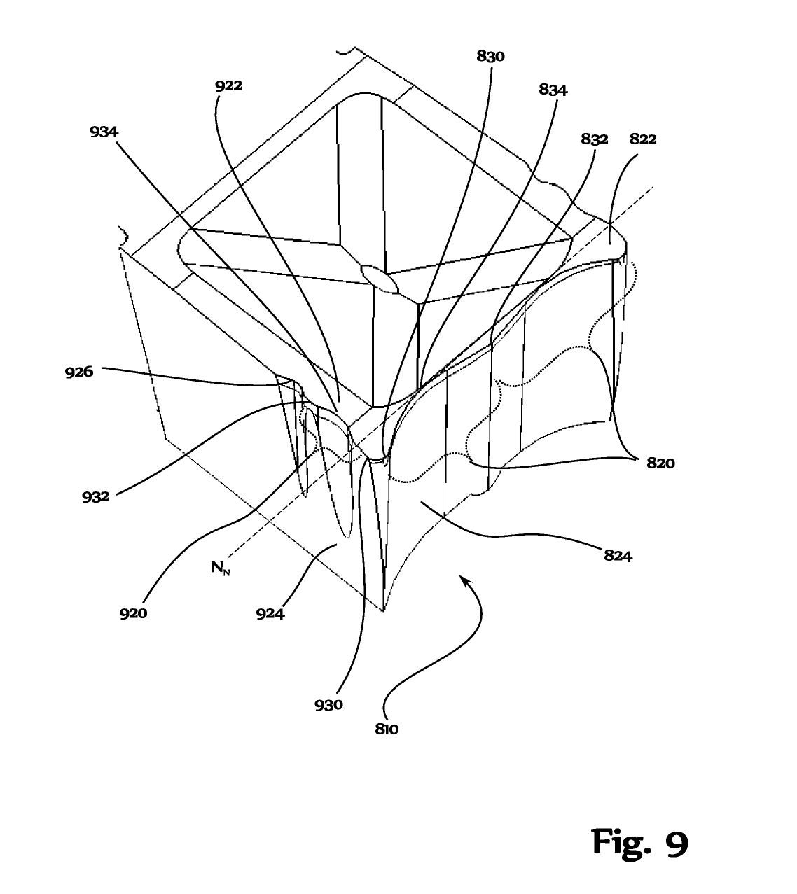

Attention is now directed to FIG. 6 and FIG. 8. A fourth embodiment of an at least one segment 720 of the tool 510 (illustrated only partially) is shown. The at least one fourth segment 720 may have many features similar to those of the at least one first segment 120. Similar features will be related to with similar numerals, increased by 600. The at least one fourth segment 720 comprises a first surface 722 and a second surface 724. The first surface 722 and the second surface 724 meet at an edge 726. The edge 726 meanders to comprise at least one first peak 730 and at least one second peak 732 with a nadir 734 interposed therebetween. The first and second peaks 730, 732 are defined as local maxima, while the nadir 734 is defined as a local minimum of the edge 726 of the at least one fourth segment 720 of the tool 510. In the fourth embodiment discussed here, the first surface 722 of the at least one fourth segment 720 may act as a rake face, while the second surface 724 of the at least one fourth segment 720 may act as a relief face, as is known in the art.

The edge 726 of the at least one fourth segment 720 extends from the first peak 730 dipping down to the nadir 734 and away therefrom to the second peak 732. A nadir line L_{N} to the edge 726 passes through the nadir 734. A first peak line L_{P1} and a second peak line L_{P2} to the edge 726 run parallel to the nadir line L_{N} through the first peak 730 and the second peak 732 respectively. In this particular embodiment of the at least one fourth segment 720, a first depth D₁ between the nadir line L_{N} and the first peak line L_{P1} is greater than a second depth D₂ between the nadir line L_{N} and the second peak line L_{P2}. A nadir normal N_{N} normal to the nadir 734, a first peak normal N_{P1} normal to the first peak 630, and a second peak normal N_{P2} normal to the second peak 732 extends parallel to each other and perpendicularly to the nadir line L_{N}, first peak line L_{P1} and the second peak line L_{P2}. A first breadth B₁ between the nadir normal N_{N} and the first peak normal N_{P1} is smaller than a second breadth B₂ between the nadir normal N_{N} and the second peak normal N_{P2}. When two or more fourth segments 720 exist adjacent each other on a same or similar bearing, their respective nadirs 734 may rest at the distance D₁ from the adjacent first peak 730.

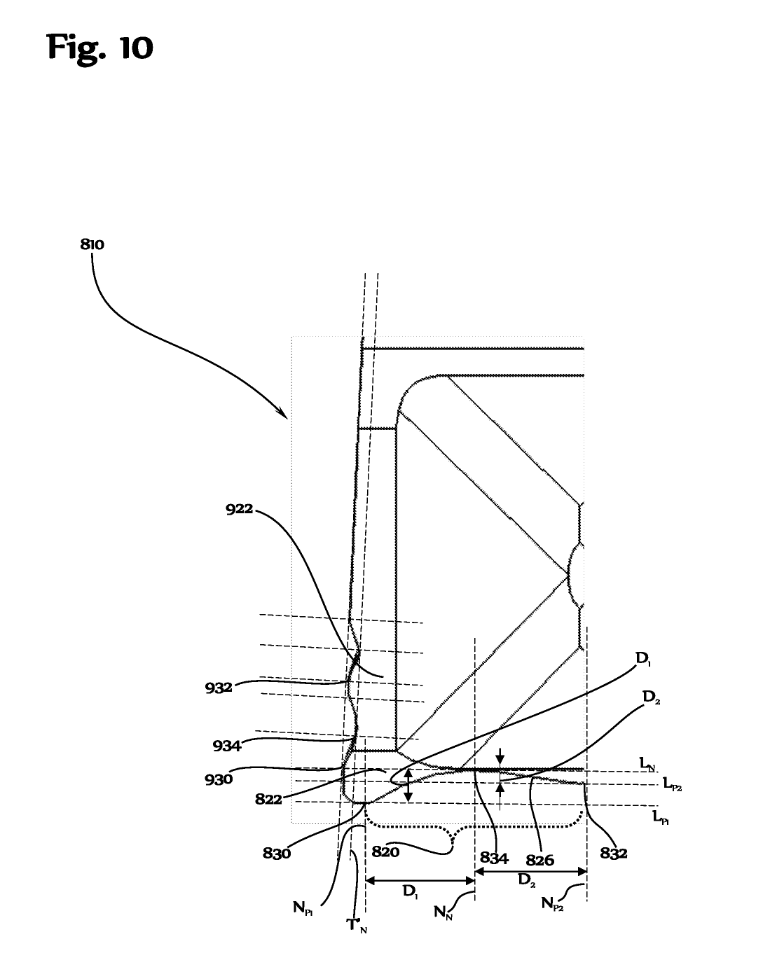

Directing attention now to FIGS. 9 and 10, there is disclosed a fifth exemplary-only embodiment of an at least one segment 820 of a tool and/or an insert 810 (illustrated only partially). The tool and/or insert 810 of this particular, illustrative-only embodiment has two adjoining segments 820 on a generally forward bearing and at least one sixth segment 920 on a generally transverse bearing. Different annotations are used for the forward segments 820 and for the transverse segments 920 in order to stress the fact that the forward and the transverse segments need not be identical. However, the forward fifth segment 820 and the transverse sixth segment 920 may have many features similar to those of the at least one first segment 120. Similar features will be related to with similar numerals, increased by 700 for the fifth segment 820 and by 800 for the sixth segment 920. For the most part, reference will be made to the fifth segment 820. The at least one fifth segment 820 comprises a first surface 822 and a second surface 824. The first surface 822 and the second surface 824 meet at an edge 826. The edge 826 meanders to comprise at least one first peak 830 and at least one second peak 832 with a nadir 834 interposed there-between. The first and second peaks 830, 832 are defined as local maxima, while the nadir 834 is defined as a local minimum of the edge 826 of the at least one fifth segment 820 of the tool and/or insert 810. In the fifth embodiment discussed here, the first surface 822 of the at least one fifth segment 820 may act as a rake face, while the second surface 824 of the at least one fifth segment 820 may act as a relief face, as is known in the art.

The edge 826 of the at least one fifth segment 820 extends from the first peak 830 dipping down to the nadir 834 and away therefrom to the second peak 832. A nadir line L_{N} to the edge 826 passes through the nadir 834. A first peak line L_{P1} and a second peak line L_{P2} to the edge 826 run parallel to the nadir line L_{N} through the first peak 830 and the second peak 832 respectively. In this particular embodiment of the at least one fifth segment 820, a first depth D₁ between the nadir line L_{N} and the first peak line L_{P1} is greater than a second depth D₂ between the nadir line L_{N} and the second peak line L_{P2}. A nadir normal N_{N} normal to the nadir 834, a first peak normal N_{P1} normal to the first peak 830, and a second peak normal N_{P2} normal to the second peak 832 ex-tend parallel to each other and perpendicularly to the nadir line L_{N}, first peak line L_{P1} and the second peak line L_{P2}. A first breadth B₁ between the nadir normal N_{N} and the first peak normal N_{P1} is smaller than a second breadth B₂ between the nadir normal N_{N} and the second peak normal N_{P2}. In this particular embodiment, and as may best be noticed on FIG. 9, where there are two fifth segments 820 disposed side-by-side on the forward bearing, their respective nadirs 834 may rest at the distance D₁ from the adjacent first peak 830.

Similarly, the at least one sixth segment 920 comprises a first transverse surface 922 and a second transverse surface 924. The first transverse surface 922 and the second transverse surface 924 meet at a transverse edge 926. The transverse edge 926 meanders to comprise at least one first transverse peak 930 and at least one transverse second peak 932 with a transverse nadir 934 interposed therebetween. The transverse first and sec- and peaks 930,932 are defined as local maxima, while the transverse nadir 934 is defined as a local minimum of the transverse edge 926 of the at least one sixth segment 920 of the tool and/or insert 810. A transverse nadir line L′_{N} to the transverse edge 926 passes through the transverse nadir 934.

All directional references (such as, but not limited to, upper, lower, upward, downward, right, left, rightward, leftward, top, bottom, above, below, vertical, horizontal, clockwise, and counter-clockwise, lineal, axial and/or radial, or any other directional and/or similar references) are only used for identification purposes to aid the reader's understanding of illustrative embodiments of the present disclosure, and may not create any limitations, particularly as to the position, orientation, or use unless specifically set forth in the claims. Similarly, joinder references (such as, but not limited to, attached, coupled, connect, accommodate and the like and their derivatives) are to be construed broadly and may include intermediate members between a connection of segments and relative movement between segments. As such, joinder references may not necessarily infer that two segments are directly connected and in fixed relation to each other.

In some instances, components are described with reference to “ends” having a particular characteristic and/or being connected with another part. However, those skilled in the art will recognize that the present disclosure is not limited to components which terminate immediately beyond their points of connection with other parts. Thus, the term “end” should be interpreted broadly, in a manner that includes areas adjacent, rearward, forward of, or otherwise near the terminus of a particular segment, link, component, part, member or the like. Additionally, all numerical terms, such as, but not limited to, “first”, “second”, “fourth”, or any other ordinary and/or numerical terms, should also be taken only as identifiers, to assist the reader's understanding of the various embodiments, variations and/or modifications of the present disclosure, and may not create any limitations, particularly as to the order, or preference, of any embodiment, variation and/or modification relative to, or over, another embodiment, variation and/or modification.

In methodologies directly or indirectly set forth herein, various steps and operations are described in one possible order of operation, but those skilled in the art will recognize that steps and operations may be rearranged, replaced, or eliminated without necessarily departing from the spirit and scope of the present disclosure as set forth in the claims. It is intended that all matter contained in the above description or shown in the accompanying drawings shall be interpreted as illustrative only and not limiting. Changes in detail or structure may be made without departing from the spirit of the present invention as defined in the appended claims.

While an exemplary embodiment has been described and shown in the accompanying drawings, it is to be understood that such an embodiment is merely illustrative of and not restrictive on the broad present disclosure, and that this disclosure may not be limited to the specific constructions and arrangements shown and described, since various other modifications and/or adaptations may occur to those of ordinary skill in the art. It is to be under-stood that individual features shown or described for the exemplary embodiment in the context of functional segments and such features may be replicated, or be omitted within the scope of the present invention and without departing from the spirit of the present disclosure as may be defined in the appended claims.

1. An edge formed at a meeting of a first surface and a second surface comprises at least one segment extending from a first peak to a second peak through a nadir disposed therebetween, the first peak having a first peak line passing therethrough, the second peak having a second peak line passing therethrough, and the nadir having a nadir line passing therethrough, wherein
the first peak line, the second peak line, and the nadir line are parallel to each other, and wherein
a first depth D1 between the nadir line and the first peak line is greater than a second depth D2 between the nadir line and the second peak line.

2. The edge of claim 1, wherein the first surface acts as a rake face while the second face acts as a relief face.

3. The edge of claim 1, wherein the first surface acts as a relief face while the second face acts as a rake face.

4. The edge of claim 2, wherein the rake face undulates.

5. The edge of claim 3, wherein the relief face undulates.

6. The edge of claim 1, comprising a plurality of adjacent segments each meandering from the first peak to the second peak through the nadir, the first peaks defining a first peak line, the second peaks defining a second peak line and the nadirs defining a nadir line, wherein the first peak line is associated with a first peak plane extending parallel to a second peak plane associated with the second peak line and parallel to a nadir plane extending through the nadir line.

7. An edge formed at a meeting of a first surface and a second surface comprises at least one segment extending from a first peak to a second peak through a nadir disposed therebetween, the first peak having a first peak normal passing therethrough, the second peak having a second peak normal passing therethrough, and the nadir having a nadir normal passing therethrough, wherein
the first peak normal, the second peak normal, and the nadir normal are parallel to each other and extend generally transversely to the edge, and wherein
a first breadth B1 between the nadir normal and the first peak normal is smaller than a second breadth B2 between the nadir normal and the second peak normal.

8. The edge of claim 7, wherein the first surface acts as a rake face while the second face acts as a relief face.

9. The edge of claim 7, wherein the first surface acts as a relief face while the second face acts as a rake face.

10. The edge of claim 8, wherein the rake face undulates.

11. The edge of claim 9, wherein the relief face undulates.

12. The edge of claim 1, comprising a plurality of adjacent segments, each segment meandering from the first peak to the second peak through the nadir, wherein
the plurality of segments is arranged so that two adjacent first peaks merge.

13. The edge of claim 7, comprising a plurality of adjacent segments, each segment meandering from the first peak to the second peak through the nadir, wherein
the plurality of segments is arranged so that two adjacent second peaks merge.

14. The edge of claim 13, wherein two adjacent nadirs are separated by two merging first peaks.

15. The edge of claim 13, wherein two adjacent nadirs are separated by two merging second peaks.
